(19) United States
(12) Patent Application Publication
(10) Pub. No.: US 2014/0047231 A1
(43) Pub. Date: Feb. 13, 2014

(54) Secure Sub-Joined Computing Device

(71) Applicants: Darren Lynn Cummings, Chandler, AZ (US); Richard Wayne Harding, Chandler, AZ (US)

(72) Inventors: Darren Lynn Cummings, Chandler, AZ (US); Richard Wayne Harding, Chandler, AZ (US)

(73) Assignee: CUMMINGS ENGINEERING CONSULTANTS INCORPORATED, Chandler, AZ (US)

(21) Appl. No.: 13/413,959

(22) Filed: Mar. 7, 2012

Related U.S. Application Data
(60) Provisional application No. 61/450,564, filed on Mar. 8, 2011.

(51) Int. Cl. G06F 21/60; G06F 13/38

(52) U.S. Cl. CPC G06F 21/602; G06F 13/385
USPC 713/150; 710/62

(57) ABSTRACT

A system includes a sleeve capable of allowing a host-computing device to be positioned therein. The sleeve itself includes a processing device and a serial interface adapter to allow communication between the secure sub-joined computing device and the host communication device. The secure sub-joined computing device will include an authentication device to authenticate the identity of the user. The secure sub-joined computing device will be able to accommodate a wide variety of host devices and provide an exclusive computing environment where strong authentication and encryption can be performed with or without the knowledge of the host device and host means to communicate the data from the device. The secure sub joined computing device can be configured to be limited to operate within a configured geographic boundary. The system includes software such as the source or executable files necessary to perform the instructions or algorithms.

This application claims the benefit of U.S. Provisional Application Ser. No. 61/450,564 filed Mar. 8, 2011. The contents of co-pending U.S. patent application Ser. No. 12/916,535 entitled “Secure Communication System for Mobile Devices” to Jones et al., filed Oct. 30, 2010, and co-pending U.S. patent application Ser. No. 12/916,522, entitled “Technique for Bypassing an IP PBX” to Patel et al., filed Oct. 30, 2010, are incorporated herein by reference in their entirety.

### FIELD OF THE INVENTION

The present invention relates to the field of computer security, and, more particularly, to a sub joined computing device, system, and methods to provide enhanced security features for a host-computing device.

### BACKGROUND

According to a recent study, about 425 million smart phones and tablet computers are expected to ship globally this year. Yet despite the enormous popularity and wide range of applications available, such commercial mobile computing devices do not offer sufficient security features. At the same time, users feel comfortable with using the mobile devices that they have.

### BRIEF SUMMARY OF THE INVENTION

In one embodiment of the invention is a secured sub joined computing device comprising a sleeve capable of allowing a host-computing device to be positioned therein. Next, a processing device, integral with the sleeve, is adapted to allow communication with a host-computing device, when the host-computing device is positioned into the sleeve. Next a battery charging circuit and a power measurement device power the components of the sub joined computing device and provide auxiliary power for the host platform interface. Next, the system may include secured peripherals coupled to the sub joined computing device to enhance the input and output capabilities of the host-computing device such as secured memory, wireless connectivity to a network, and video capturing. Next the sub joined computing device may also include radios such as 3G, 4G, Wi-Fi, Wi-Max, and LTE. Next the sub joined computing device may also include a trusted platform module to safely store the cryptographic keys necessary to secure the components of the system. Next, the sub joined computing device may also include a processing device to perform the required instructions and algorithms for configuring and performing security functions. Finally, the sub joined computing device may also include processing device support components such as memory and co-processors to support the processing device.

In one embodiment of the invention is a system comprising a secure sub joined computing device. Next a host-computing device is coupled to the secure sub joined computing device via a host platform interface. Finally, the system includes embedded software such as the source or executable files necessary to perform the instructions or algorithms to perform security functions. The secure sub joined computing device is configured to perform security functions, such as data encryption and decryption, for the host-computing device.

One embodiment of the invention is a method operating on the sub joined computing device having physical memory comprising performing authentication management. Next, the method includes providing group and contact management such as real-time addition or revocation. Next, the method includes performing sanitization management. Next, the method includes providing data-in-transit protection such as peer-to-peer encryption and security. Next, the method includes ensuring data-at-rest protection and data-in-use protection. Next, the method includes providing seamless secure mobility management. Finally, the method includes providing an audit chain such as the end-user capability to define chain of custody.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a diagram of an exemplary embodiment illustrating a system to perform security functions for a host-computing device in accordance with the teachings of the present invention;

FIG. 2 is a diagram of an exemplary embodiment illustrating a secured sub joined computing device comprising a sleeve capable of allowing a host-computing device to be positioned therein to perform security functions for the host-computing device in accordance with the teachings of the present invention.

### DETAILED DESCRIPTION OF THE INVENTION

According to a preferred embodiment of the present invention, a secure sub joined computing device includes a sleeve capable of allowing a host-computing device to be positioned therein. Most preferably, the host-computing device is a computing device having a relatively thin profile, such as a tablet computer (e.g., Apple iPad) or a smart phone (e.g., Blackberry, iPhone, etc.). The exact dimensions of the sleeve will vary depending on the size of the particular host-computing device. Preferably, the sleeve itself will include a computing device, preferably, as an integral part of, or attachment to, the sleeve. Preferably, the sleeve will also include a communications (serial or parallel) interface adapter to allow communication between the secure sub joined computing device and the host-computing device. Preferably, when the host-computing device is placed into the sleeve, the communications interface adapter connects with the communication port of the host-computing device. Additionally, preferably, the secure sub joined computing device will include additional functionality, to include but not to be limited to input devices such as an authentication device (e.g., smart card reader or biometric device), cameras, microphones, etc. and could also include output devices, to include but not be limited to a printer, speaker, display, etc. The additional functionality can be contained or embedded in the sleeve or could be added as an inserted, separately constructed peripheral element. This element could also contain its own computing device and will communicate to the sleeve through a communication interface (serial or parallel). The peripheral element could be designed to be unique to the sleeve or designed to be interchangeable among any sleeve design. This would allow peripheral element function to be transferred freely from host-computing device to host-computing device. The peripheral element may, or may not, also contain a secure identification structure that would validate compatibility between the peripheral element and the sleeve. This would prevent the use of unauthorized peripheral elements to be inserted into the sleeve.

Preferably, the secure sub joined computing device will be able to accommodate a wide variety of host devices, commercial or proprietary, and provide an exclusive computing environment where strong authentication and encryption can be performed with or without the knowledge of the host device and host means to communicate the data from the device.

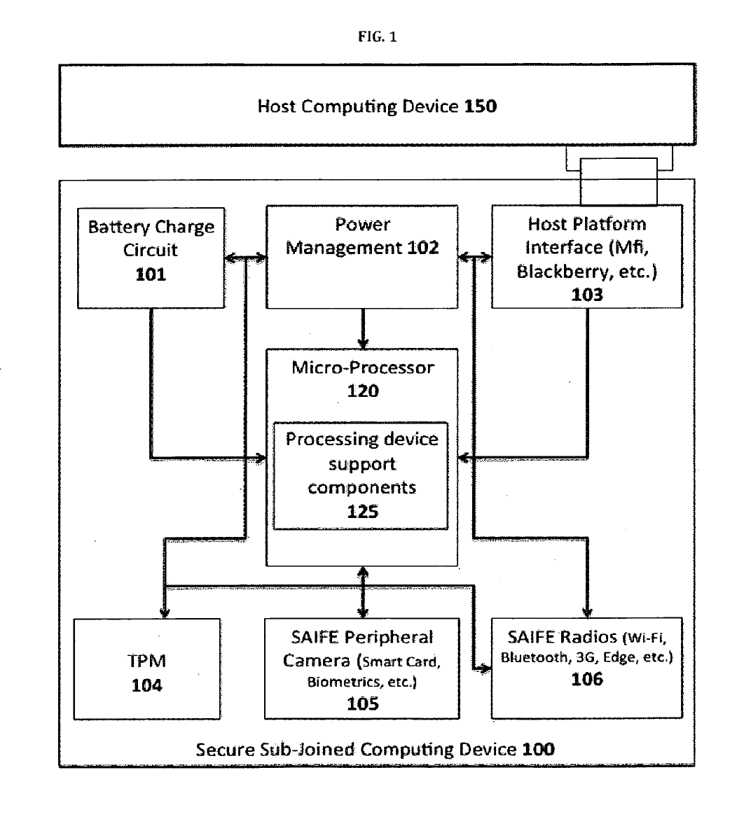

FIG. 1 illustrates an exemplary system of the present invention. As shown, a host-computing device 150 is coupled to a secure sub joined computing device 100 via a host platform interface 103. In the case where the host-computing device 150 is an Apple i-Pad, for example, the host platform interface 103 would be an “MFi” approved interface. In other cases, the host platform interface 103 could be a USB connection, for example. The connection between the host-computing device 150 and the secure sub joined computing device 100 may also be established via wireless networks. For example, the radios (e.g. Wi-Fi, Bluetooth, 3G, Edge, etc.) 106 may be used to couple the secure sub joined computing device 100 to the host-computing device 150. This allows the invention to work when a host-computing device 150 has a proprietary interface, or no external hardware interface at all. In this situation, the connection to the host-computing device 150 may be made over a wireless connection using a universal wireless standard such as Bluetooth or Wi-Fi as an alternative to a hardware connection. The secure sub joined computing device 100 may include multiple radios 106, or a radio capable of channel-switching, to connect with the host-computing device 150 and an external wireless network. The invention provides a ubiquitous solution allowing use of hardware or wireless connections, or both—including simultaneously or at separate instances. For example, a host-computing device 150 may be able to communicate to the sub joined computing device 100 via a hardware-based connection and at other times it may be advantageous for the connection to be established using the devices' radios via a wireless connection, or vice versa.

Also, as illustrated, the secure sub joined computing device 100 includes a power supply (battery charge circuit 101 and power management 102) to provide sufficient power to the components, as needed. In addition, auxiliary power could be supplied to the host-computing device 150 (though this is not shown). Additionally, as indicated, the secure sub joined computing device 100 can support a wide variety of peripherals (e.g., video camera, smart card, biometric reader, etc.) 105 and radios (e.g. Wi-Fi, Bluetooth, 3G, Edge, etc.) 106. Preferably, the secure sub joined computing device 100 could include a Trusted Platform Module (TPM) 104 to store the cryptographic keys used by the software of the invention. Preferably, each of the components of the secure sub joined computing device 100 described above includes embedded code that can be updated, most preferably via an external cable interface. This would provide a convenient method for provisioning the components based on the latest specifications.

At the heart of the secure sub joined computing device 100 is processing device (e.g., microprocessor, microcontroller, etc.) 120 and processing device support components (e.g., memory, clocking, etc.) 125, which includes the software of the invention stored therein. The software of the invention enables implementation of various security and cryptographic features, some of which are disclosed in co-pending U.S. patent application Ser. No. 12/916,535 entitled “Secure Communication System for Mobile Devices” to Jones et al., filed Oct. 30, 2010, and co-pending U.S. patent application Ser. No. 12/916,522, entitled “Technique for Bypassing an IP PBX” to Patel et al., filed Oct. 30, 2010, the contents of both of these applications incorporated herein by reference in their entirety. Such features include authentication management (including real-time ad hoc secure enclave management), group and contact management (including real-time addition/revocation), sanitization management (including rapid memory wiping), data-in-transit protection (including peer-to-peer encryption and security, “stealth” call set up techniques, no “man-in-the-middle” security, and key roll-over and related features), data-at-rest protection, data-in-use protection, seamless secure mobility management (including the ability to roam from one disparate network to another, while in secure mode, without losing crypto synch), and audit chain (including end-user capability to define chain of custody).

Notable advantages of the present invention include, without limitation, the ability to provide a mutually exclusive, independent computing environment whereby enhanced security can be offered without knowledge of the host device and the host-computing environment. Preferably, this invention allows a user to carry their security credentials with them in the secure sub joined computing device 100 independent of which host-computing device(s) 150 used such as environments where shared computing resources are found. Further, often commercial computing device manufacturers do not alter their devices to offer security to accommodate privileged data environments such as found in various environments such as medical community, financial community, defense and government communities, etc. This invention allows existing commercial devices to operate at a much higher level of protection than could be otherwise allowed on the host device.

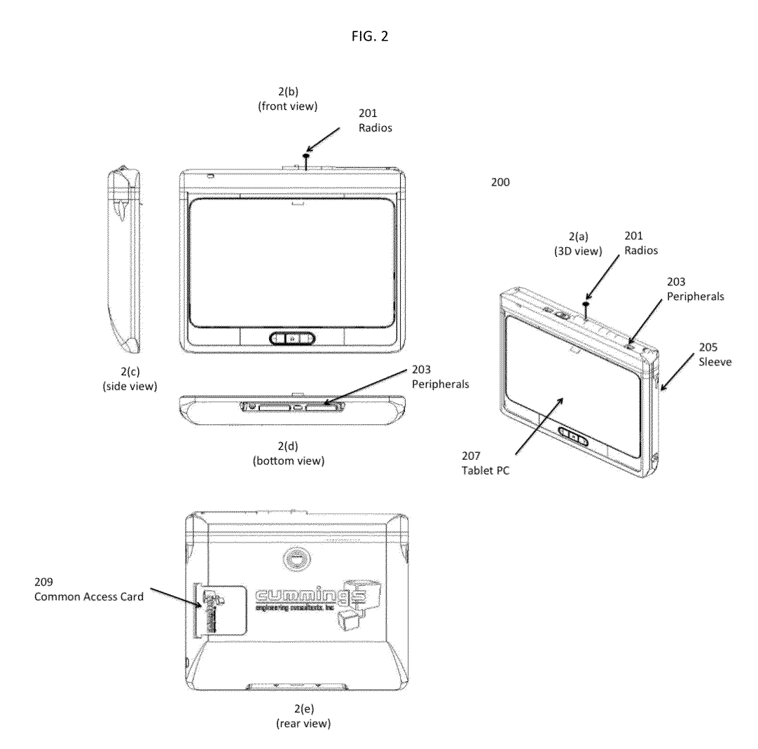

FIGS. 2(a) through 2(e) show various views of an exemplary system 200 including the secure sub joined computing device 100. As illustrated, the secure sub joined computing device 100 can accommodate a tablet PC. In this embodiment, the tablet PC can connect to 802.11g (minimum) WPA2-Enterprise wireless networks using an encryption module. Advantageously, the Wi-Fi radio in the sleeve can be used rather than the tablet's unsecured radio. While connected to the network via the secure sub joined computing device 100, the user can access PKI-controlled websites by using the currently inserted common access card (CAC) for authentication. The website will be displayed in a web browser application on the tablet PC. With CAC integration, the secure sub joined computing device 100 can use the inserted CAC card as a cryptographic ignition key, requiring a valid CAC with valid PIN or passcode to perform any encryption operations. The secure sub joined computing device 100 can store (data-at-rest) sensitive data in internal memory, protected with encryption. This data will be encrypted using the user's CAC card, and only be able to be decrypted when the CAC card is inserted and unlocked. Because the secure sub joined computing device 100 includes auxiliary batteries, using the secure sub joined computing device 100 provides additional battery life in addition to ruggedness. As constructed, the secure sub joined computing device 100 contains a modular electronics design, such that by making tradeoffs in the number of auxiliary batteries and additional weight, the secure sub joined computing device 100 can provide other data collection functionalities such as: (1) biometric enrollment/verification devices; (2) onboard cameras, permitting video recording or videoconferencing through the cryptographic module; (3) GPS antenna, with position information protected (enabling the “Geo-Spacial” features described hereinafter); and (4) additional radios, including options for tactical mesh IP, anti jam or beyond-line-of-sight communications, etc.

In addition to the features described above, the secure sub joined computing device 100 can also be configured to be limited to operate, or be prevented to operate, within a configured geographic boundary. Periodically, during operation, the device can determine its position using a position sensor (such as GPS, accelerometer, or a gyroscope) or by employing triangulation. After determining the position, a secure routine with the device can then determine if the device is geographically limited, and, if so, whether the device is within the limited area. If the device has been moved from the allowed area of operation, the routine can cause the device to be locked and refuse access, cause a panic data wipe of the device, or some other configurable function. This feature also provides the ability to dynamically provision a slow-moving or fixed surveillance asset to a contact list, permitting two-way trusted encrypted communication with the asset without requiring explicit per-instance configuration. This feature would additionally provide the ability to dynamically discover and provision other users who are using enabled communications devices offering the option to allow the end-user the ability to explicitly allow itself to be added to the secure group thus permitting two-way trusted encrypted communication.

By way of example, an encrypted IP security camera with remote control functionality is procured for a new mission. Before placement, the camera is provisioned into a secure enclave, and, furthermore it is registered with the Geolocation Service as a discoverable asset. The camera is placed in a strategic location with sufficient network bandwidth for its information payload. After placement, the camera periodically uses a built-in location device (e.g., GPS) to determine its physical location to its maximum precision. It also periodically downloads configuration data from the network. The downloaded configuration data contains parameters defining a geographical area relative to the camera's physical location. This geographical area can be defined as any two-dimensional field of points where point (0,0,0) is defined as the camera's location. Whenever the camera's physical location changes, the camera sends an encrypted geographical registration notification to the Geolocation Service containing a coarse-resolution physical location, provided by applying a mathematical rounding function to the precise location information. The level of obfuscation applied is contained within the configuration parameters. The registration notification sent by the camera also contains a coarse discovery radius, also a configurable value.

From the perspective of a mobile user, periodically or upon user-invocation the device will determine its physical location and send a coarse-resolution geographic discovery request to the Geolocation Service. The Geolocation Service will determine potential matches based on the coarse location of the mobile user and the coarse location of all registered discoverable assets and their discovery radii. The potential matches are then provided in response to the mobile user in the form of secure contacts. The mobile user device then can validate trust to each of the provided discoverable assets, and then either display discoverable assets as potential devices for the user to query at their leisure, or can automatically query each discoverable asset to determine whether it is valid for communication. Regardless of how the query begins, the mobile device sends an encrypted message to the discoverable asset through the network containing the device's high-precision location. The discoverable asset decrypts the message, validates the trust to the mobile device and then determines whether the mobile device's location is within the configured valid-location space. If the device is not within its valid space, the asset denies the query with an encrypted failure response. Otherwise, the asset responds with an encrypted access-granted notification. At this point the mobile device can set up an encrypted data session with the discoverable asset using the normal means to exchange data.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A secured sub joined computing device comprising: a sleeve capable of allowing a host-computing device to be positioned therein; a processing device, integral with the sleeve, the processing device adapted to allow communication with the host-computing device, when the host-computing device is positioned into the sleeve; an interface to enable communication between the processing device and the host-computing device; a battery charging and power measurement circuit; secured peripherals; radios; a trusted platform module; and processing device support components.

2. The secured sub joined computing device of claim 1, wherein the battery charging and power measurement circuit provide power to the system including auxiliary power to the host-computing device.

3. The secured sub joined computing device of claim 1, wherein the communication interface is the host platform interface comprising a serial or parallel communication interface such as a MFi or USB connection.

4. The secured sub joined computing device of claim 1, wherein the communication interface is made over a wireless connection using the devices' radios.

5. The secured sub joined computing device of claim 1, wherein the secured peripherals comprise one or more of a camera, smart card, biometric reader, keyboard, mouse, voice recorder, or external storage.

6. The secured sub joined computing device of claim 1, wherein the radios comprise a receiver and transmitter, or a transceiver, such as Wi-Fi, Bluetooth, 3G, 4G, Edge, LTE, or Wi-Max.

7. The secure sub joined computing device of claim 1, wherein the security functions include cryptographic security functions such as data encryption or decryption.

8. The secured sub joined computing device of claim 1, wherein the trusted module platform stores the cryptographic keys used by the embedded code to perform data encryption and decryption.

9. The secured sub joined computing device of claim 1, wherein the processing device includes a microprocessor to execute the instructions and algorithms of the embedded code.

10. The secured sub joined computing device of claim 1, wherein the processing device support components include memory, co-processors, chipsets, and ancillary hardware needed to support execution of the instructions and algorithms of the embedded code.

11. The secure sub joined computing device of claim 1, further comprising an authentication device such as one or more of a biometric authentication device or a smart card reader.

12. The secure sub joined computing device of claim 1, further including wireless radios such as on or more of Wi-Fi, Wi-Max, 3G, 4G, Edge, or LTE.

13. The secure sub joined computing device of claim 1, further including a position sensor such as one or more of a GPS, an accelerometer, or a gyroscope.

14. A method operating on the sub joined computing device having physical memory comprising: performing authentication management; providing group and contact management such as real-time addition or revocation; performing sanitization management;
providing data-in-transit protection such as peer-to-peer encryption and security; ensuring data-at-rest protection; ensuring data-in-use protection; providing seamless secure mobility management; and providing an audit chain such as the end-user capability to define chain of custody.

15. The method of claim 14, wherein sanitization management includes rapid memory wiping enabled based on the device's proximity to a configured geographic boundary.

16. The method of claim 14, wherein authentication management includes real-time ad hoc secure-enclave management.

17. The method of claim 14, wherein providing seamless secure mobility management includes the ability to roam from one disparate network to another, while in secure mode, without losing cryptographic synchronization.

18. A system comprising: a secure sub joined computing device; a host-computing device positioned therein and coupled with the secure sub joined computing device via a communication interface; and embedded code to perform security functions.

19. The system of claim 18, wherein the host-computing device is one of a tablet computer or a mobile phone.

20. The system of claim 18, wherein the communication interface is made over a hardware-based connection using the host platform interface.

21. The system of claim 18, wherein the communication interface is made over a wireless connection using the devices' radios.

22. The system of claim 18, wherein the embedded code includes the source or executable files necessary to perform the instructions or algorithms to perform security functions.
